(19) United States
(12) Patent Application Publication
(10) Pub. No.: US 2010/0013657 A1
(43) Pub. Date: Jan. 21, 2010

(54) WARNING DEVICE AND COMPUTER READABLE RECORDING MEDIUM

(75) Inventors: Yasunori OHTA, Kanagawa (JP); Naoyuki NISHINO, Kanagawa (JP); Keiji TSUBOTA, Kanagawa (JP); Yutaka YOSHIDA, Kanagawa (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/500,622

(22) Filed: Jul. 10, 2009

(30) Foreign Application Priority Data
Jul. 17, 2008 (JP) 2008-186347

(51) Int. Cl. G08B 1/08; G08B 21/00

(52) U.S. Cl. 340/687

(57) ABSTRACT

A warning device includes an acquisition unit which acquires history information that expresses a history of past connected states between a communication cable and a connection terminal of a radiographic device. On the basis of the acquired history information, a judgment unit judges whether or not the communication cable that is connected to the connection terminal is unsuitable for transfer of image information. If it is judged that the communication cable connected to the connection terminal is unsuitable for transfer of the image information, warning unit is controlled such that a warning is given.

### CROSS-REFERENCE TO RELATED APPLICATION

This application claims priority under 35 USC 119 from Japanese Patent Application No. 2008-186347 filed on Jul. 17, 2008, the disclosure of which is incorporated by reference herein.

### BACKGROUND OF THE INVENTION

1. Field of the Invention

The present invention relates to a warning device and to a computer readable medium on which is recorded a program for processing for giving a warning.

2. Description of the Related Art

FPDs (Flat Panel Detectors), in which a radiation-sensitive layer is disposed on a TFT (Thin Film Transistor) active matrix substrate and that can convert radiation directly into digital data, have been put into practice in recent years. Portable radiographic devices (hereinafter called “electronic cassettes”), that generate image information expressing a radiographic image expressed by radiation irradiated by using an FPD or the like and that store the generated image information, have been put into practice.

Because the electronic cassette is portable, an image of a patient can be captured as is while on a stretcher or bed, and the place to be image captured can be adjusted by changing the position of the electronic cassette. Therefore, even patients who cannot move can be image captured flexibly.

Due to limitations with respect to the power source and data transfer and the like, the electronic cassette is generally connected by a communication cable to a terminal for control (a so-called console). Therefore, a connection terminal for the attaching and detaching of the communication cable is provided at the electronic cassette. At the time when caputring of a radiographic image is carried out, the connection terminal is connected by the communication cable, and the electronic cassette transmits the image information generated by image capturing to the console via the communication cable.

If the communication cable can be attached and detached, there are cases in which the cable becomes disconnected. In particular, it is easy for cable disconnection to arise because the electronic cassette is moved in order to adjust the image capturing position at the time of image capturing in a state in which the communication cable is connected.

As a technique that deals with this disconnecting of the cable, Japanese Patent Application Laid-Open (JP-A) No. 2007-44068 discloses a technique of prohibiting image capturing when the communication cable has become disconnected.

### SUMMARY OF THE INVENTION

The present invention has been made in view of the above circumstances and provides a warning device and to a computer readable medium on which is recorded a program for processing for giving a warning.

According to an aspect of the invention, there is provided a warning device including: an acquisition unit acquiring history information expressing a history of past connected states between a communication cable and a connection terminal of a radiographic device that has a generation unit, which generates image information expressing a radiographic image expressed by irradiated radiation, and that transfers generated image information via the communication cable connected to the connection terminal; a judgment unit judging, on the basis of the history information acquired by the acquisition unit, whether or not the communication cable that is connected to the connection terminal is unsuitable for transfer of the image information; and a controller controlling a warning unit such that a warning is given in a case in which the judgment unit judges that the communication cable connected to the connection terminal is unsuitable for transfer of the image information.

According to another aspect of the invention, there is provided a computer readable medium storing a program causing a computer to execute a process for giving a warning, the process including: acquiring history information expressing a history of past connected states between a communication cable and a connection terminal of a radiographic device that has a generation unit, which generates image information expressing a radiographic image expressed by irradiated radiation, and that transfers generated image information via the communication cable connected to the connection terminal; judging, on the basis of the acquired history information, whether or not the communication cable that is connected to the connection terminal is unsuitable for transfer of the image information; and giving a warning in a case in which it is judged that the communication cable connected to the connection terminal is unsuitable for transfer of the image information.

### BRIEF DESCRIPTION OF THE DRAWINGS

Preferred embodiments of the present invention will be described in detail based on the following figures, wherein:

FIG. 1 is a block diagram showing the structure of a radiation information system relating to exemplary embodiments;

FIG. 2 is a drawing showing the situation in an operating room in which a radiographic image capturing system relating to the exemplary embodiments is set;

FIG. 3 is a perspective view showing the internal structure of an electronic cassette relating to the exemplary embodiments;

FIG. 4 is a block diagram showing the detailed structure of a radiographic image capturing system relating to a first exemplary embodiment;

FIG. 5 is an equivalent circuit diagram that focuses on one pixel portion of a radiation detector relating to the exemplary embodiments;

FIG. 6 is a timing chart showing the flow of operations at the time of image capturing a radiographic image relating to the exemplary embodiments;

FIG. 7 is a flowchart showing the flow of processings of a connected state detecting processing program relating to the first exemplary embodiment;

FIG. 8 is a graph showing an example of changes in bit error rate relating to the exemplary embodiments;

FIG. 9 is a flowchart showing the flow of processings of a transfer error occurrence predicting processing program relating to the first exemplary embodiment;

FIG. 10A is a drawing showing a region, in which a memory is embedded, of a communication cable relating to a second exemplary embodiment, and FIG. 10B is a drawing showing a region, to which identification information is added, of the communication cable;

FIG. 11 is a block diagram showing the detailed structure of a radiographic image capturing system relating to a second exemplary embodiment;

FIG. 12 is a flowchart showing the flow of processings of a connected state detecting processing program relating to the second exemplary embodiment;

FIG. 13 is a flowchart showing the flow of processings of a transfer error occurrence predicting processing program relating to the second exemplary embodiment;

FIG. 14 is a block diagram showing the detailed structure of a radiographic image capturing system relating to a third exemplary embodiment;

FIG. 15 is a perspective view showing the structure of a placement stand relating to the third exemplary embodiment;

FIG. 16 is a perspective view showing the structure of a cradle relating to the third exemplary embodiment;

FIG. 17 is a cross-sectional view showing the structure within accommodating portions relating to the third exemplary embodiment;

FIG. 18 is a flowchart showing the flow of processings of a connected state detecting processing program relating to the third exemplary embodiment;

FIG. 19 is a flowchart showing the flow of processings of a transfer error occurrence predicting processing program relating to the third exemplary embodiment;

FIG. 20 is a circuit diagram showing an example of a measuring circuit that measures the resistance value of a shield line that is incorporated in a communication cable relating to another exemplary embodiment;

FIG. 21 is a circuit diagram showing an example of a measuring circuit that measures the resistance values of two shield lines that are incorporated in a communication cable relating to another exemplary embodiment;

FIG. 22A is a drawing showing the state of a mechanical switch in a case in which a communication cable is not connected to a connection terminal, FIG. 22B is a drawing showing the state of the mechanical switch in a case in which the communication cable is connected to the connection terminal, and FIG. 22C is an equivalent circuit diagram of the mechanical switch;

FIG. 23A is a drawing showing the state of a swinging-type mechanical switch in a case in which the communication cable is not connected to the connection terminal, and FIG. 23B is a drawing showing the state of the swinging-type mechanical switch in a case in which the communication cable is connected to the connection terminal;

FIG. 24A is a drawing showing a state in which a reflecting-type sensor is provided at the connection terminal, and FIG. 24B is an equivalent circuit diagram of the reflecting-type sensor;

FIG. 25 is a drawing showing a state in which the communication cable relating to another exemplary embodiment is held by a holding member provided at the electronic cassette; and

FIG. 26A is a graph showing an example of changes in bit error rate in a case in which deterioration of the connected state is predicted, and FIG. 26B is a graph showing an example of changes in bit error rate in a case in which the connected state has deteriorated.

### DETAILED DESCRIPTION OF THE INVENTION

In cases in which a communication cable can be attached to and detached from an electronic cassette, if the cable once becomes disconnected, the connected state between the connection terminal and the communication cable becomes unstable, and there are cases in which it becomes easy for cable disconnection to arise. In such cases, in the technique of aforementioned JP-A No. 2007-44068, image capturing is prohibited due to disconnection of the cable, and radiographic images cannot be captured smoothly.

The present invention provides a warning device, that can make capturing of radiographic images be carried out smoothly, and a recording medium on which is recorded a program for processings for warning processing.

Hereinafter, exemplary embodiments for implementing the present invention will be described in detail with reference to the drawings.

### First Exemplary Embodiment

First, the structure of a radiation information system 10 relating to a first exemplary embodiment will be described.

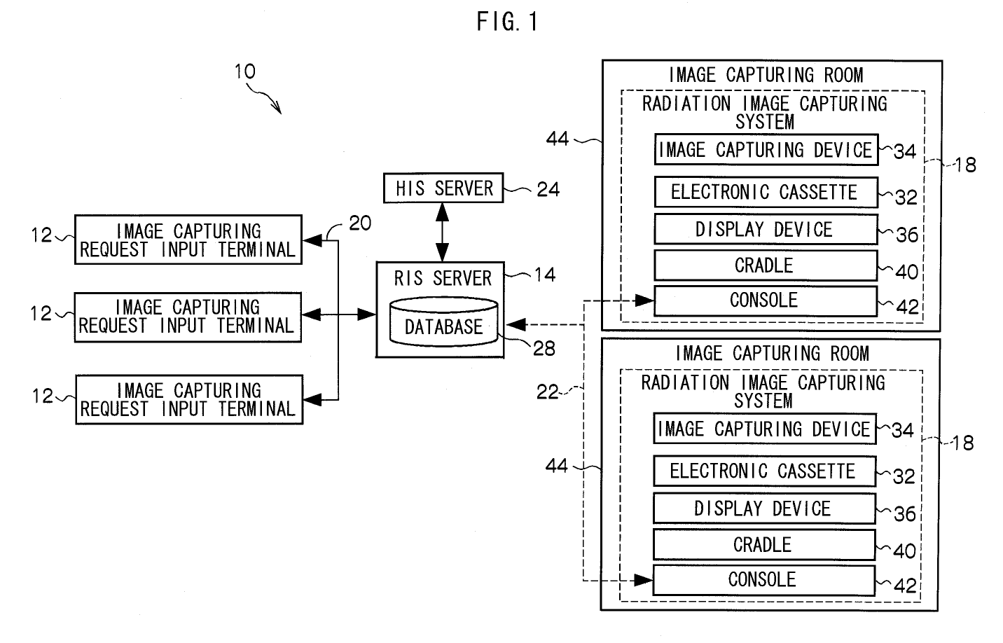

A block diagram showing the respective structural elements of the radiation information system 10 (hereinafter also called “RIS 10”) relating to the present exemplary embodiment is shown in FIG. 1.

The RIS 10 is a system for carrying out information management such as scheduling of examinations/treatments, recording of diagnoses, and the like in a radiology department, and structures a part of a hospital information system (HIS).

The RIS 10 is structured to include plural image capturing request input terminals 12 (hereinafter also called “input terminals 12”), an RIS server 14, and plural radiographic image capturing systems 18 (hereinafter called “image capturing systems 18”).

The RIS server 14 manages the entire RIS 10, and is structured such that transmission between the respective input terminals 12 and the image capturing systems 18 is possible by LAN (Local Area Network) cables 20 or a wireless LAN 22. The RIS server 14 is connected to an HIS server 24 that manages the entire HIS.

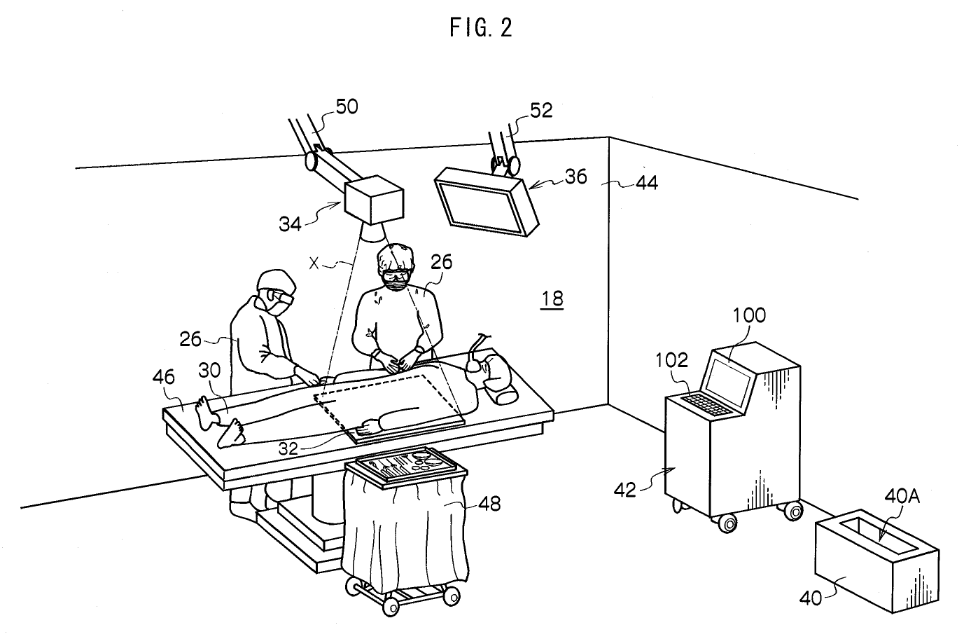

The input terminal 12 is for a doctor 26 (see FIG. 2) or a radiology technician to input and browse diagnostic information and reservations of facilities. Requests for image capturing of radiographic images (reservations for image capturing) are also made from the input terminal 12. Each of the input terminals 12 is structured from a personal computer that is equipped with a display device, and is connected to the RIS 14 by a LAN such that communication therebetween is possible.

The RIS server 14 receives image capturing requests from the respective input terminals 12, and manages the radiographic image capturing schedule at the image capturing systems 18, and is structured to include a database 28.

The database 28 includes: information relating to a patient 30 (see FIG. 2) such as attribute information of the patient 30 (name, sex, birthdate, age, blood type, patient ID, and the like), the patient's history of past illness, history of past examinations/treatments, radiographic images that were taken in the past, and the like; information relating to electronic cassettes 32 of the image capturing systems 18 such as the ID number, type, size, sensitivity, regions to be image captured at which the electronic cassette 32 can be used (contents of image capturing requests that the electronic cassette 32 can handle), the usage start date, number of times of usage, and the like; and environment information expressing the environments in which radiographic images were captured by using the electronic cassette 32, i.e., environments in which the electronic cassette 32 was used (as an example, an operating room, an image capturing room set exclusively for capturing of radiographic images, or the like).

The image capturing system 18 carries out capturing of radiographic images by operation of the doctor 26 or a radiology technician in accordance with instructions from the RIS server 14. The image capturing system 18 has: an image capturing device 34 that irradiates, onto a subject of image capturing, radiation X formed of a radiation amount conforming to image capturing conditions; the electronic cassette 32 that incorporates therein a radiation detector 60 (corresponding to a generation unit) (see FIG. 2) that detects the radiation X that has been transmitted through the patient 30 and that converts the detected radiation into radiographic image information; a display device 36 that displays a radiographic image that is based on the radiation X detected by the radiation detector; a cradle 40 that charges a battery incorporated in the electronic cassette 32; and a console 42 that controls the electronic cassette 32, the image capturing device 34, the display device 36 and the cradle 40.

A situation, in which the image capturing system 18 is set in an operating room 44 that serves as an image capturing room, is illustrated in FIG. 2 as an example of a situation in which the image capturing system 18 relating to the present exemplary embodiment is disposed. In the image capturing system 18 relating to the present exemplary embodiment, the electronic cassette 32, the image capturing device 34 and the display device 36, and the console 42 are respectively connected by cables, and transmission and reception of various types of information is carried out by wired communication. The cables that connect the respective devices are omitted from FIG. 2.

In the operating room 44 of FIG. 2, in addition to the image capturing system 18, an operating table 46 on which the patient 30 lays is provided, and an instrument table 48, on which various types of instruments that the doctor 26 uses in surgery are placed, is disposed at the side of the operating table 46. Various devices that are needed in surgery such as anesthesia equipment, suction equipment, an electrocardiograph, a blood pressure meter, and the like are disposed around the operating table 46 (these devices are omitted from FIG. 2).

The image capturing device 34 is connected to a universal arm 50, and can be moved to a desired position that corresponds to the region to be image captured of the patient 30, and can be withdrawn to a position at which it does not get in the way of the surgery performed by the doctor 26. The display device 36 is connected to a universal arm 52, and can be moved to a position at which the doctor 26 can easily confirm the captured radiographic image.

An accommodating portion 40A, in which the electronic cassette 32 can be accommodated, is formed in the cradle 40.

At times of standby, the electronic cassette 32 is stored in the accommodating portion 40A of the cradle 40, and the battery incorporated therein is charged. At times of capturing radiographic images, the electronic cassette 32 is taken-out from the cradle 40, a communication cable is connected thereto, and the electronic cassette 32 is disposed at the region to be image captured of the patient 30.

The electronic cassette 32 is not limited to cases of being used in the operating room 44, and for example, can be used in medical examinations or in doctors' rounds within a hospital as well.

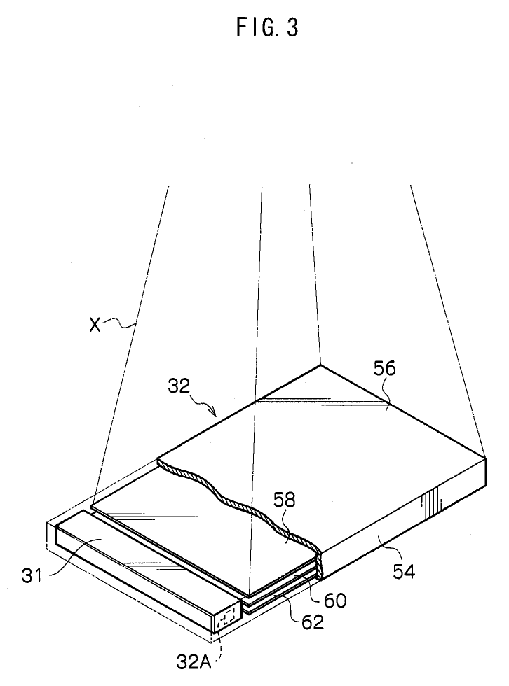

The internal structure of the electronic cassette 32 relating to the first exemplary embodiment is shown in FIG. 3.

The electronic cassette 32 has a housing 54 formed from a material through which the radiation X is transmitted, and is a structure that is waterproof and airtight. When the electronic cassette 32 is being used in the operating room 44 or the like, there is the concern that blood or other various germs will adhere thereto. Thus, by making the electronic cassette 32 be a waterproof and airtight structure and disinfectingly cleaning it as needed, one electronic cassette 32 can be used repeatedly in continuation. A connection terminal 32A for connecting a communication cable is provided at a side surface of the housing 54. A grid 58 that removes the scattered radiation of the radiation X due to the patient 30, a radiation detector 60 that detects the radiation X that has been transmitted through the patient 30, and a lead plate 62 that absorbs the back-scattered radiation of the radiation X, are disposed within the housing 54 in that order from an irradiation surface 56 side of the housing 54 on which the radiation X is irradiated. The irradiation surface 56 of the housing 54 may be made to be the grid 58.

A case 31, that accommodates a secondary battery that can be charged and electronic circuits including a microcomputer, is disposed at one end side of the interior of the housing 54. The radiation detector 60 and the electronic circuits are operated by electric power that is supplied from the secondary battery disposed in the case 31. In order to avoid damage, that accompanies the irradiation of the radiation X, to the various types of circuits that are accommodated within the case 31, it is preferable to dispose a lead plate or the like at an irradiation surface 22 side of the case 31.

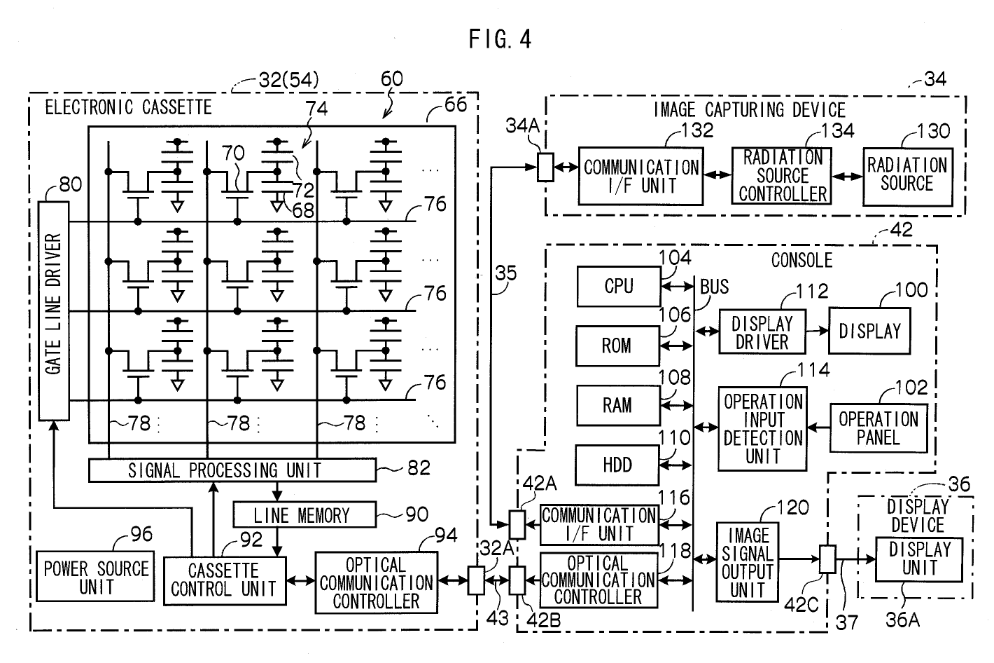

A block diagram showing the detailed structure of the radiographic image capturing system 18 relating to the present exemplary embodiment is shown in FIG. 4.

A connection terminal 34A for carrying out communication with the console 42 is provided at the image capturing device 34. A connection terminal 42A for carrying out communication with the image capturing device 34, a connection terminal 42B for carrying out communication with the electronic cassette 32, and a connection terminal 42C for outputting image signals to the display device 36, are provided at the console 42.

The image capturing device 34 is connected to the console 42 via a communication cable 35, and the display device 36 is connected to the console 42 via a display cable 37. At times of capturing radiographic images, a communication cable 43 is connected to the connection terminal 32A of the electronic cassette 32, and the electronic cassette 32 is connected to the console 42 via this communication cable 43. In the present exemplary embodiment, in order to carry out data transfer at a high speed between the electronic cassette 32 and the console 42, an optical communication cable using optical fibers is used for the communication cable 43, and the transfer of data between the electronic cassette 32 and the console 42 is carried out by optical communication.

The radiation detector 60 that is incorporated in the electronic cassette 32 is structured by layering a photoelectric converting layer, that absorbs the radiation X and converts it into charges, on a TFT active matrix substrate 66. The photoelectric converting layer is formed from, for example, an amorphous a-Se (amorphous selenium) whose main component is selenium (e.g., a content of greater than or equal to 50%). When the radiation X is irradiated, the photoelectric converting layer generates, at the interior thereof, charges (electron-hole pairs) of a charge amount corresponding to the irradiated radiation amount, and thereby converts the irradiated radiation X into charges. Instead of a radiation-charge converting material that directly converts the radiation X into charges such as amorphous selenium, the radiation detector 60 may convert the radiation X into charges indirectly by using a fluorescent material and photoelectric converting elements (photodiodes). Gadolinium oxysulfide (GOS) or cesium iodide (CsI) are well known as fluorescent materials. In this case, conversion from the radiation X into light is carried out by the fluorescent material, and the conversion from light into charges is carried out by the photodiodes that are photoelectric converting elements.

Numerous storage capacitors 68 that accumulate the charges generated at the photoelectric converting layer, and numerous pixel portions 74 having TFTs 70 for reading-out the charges accumulated in the storage capacitors 68, are arranged in the form of a matrix on the TFT active matrix substrate 66. (In FIG. 4, the photoelectric converting layer corresponding to the individual pixel portions 74 is shown schematically as photoelectric converting portions 72.) The charges, that are generated at the photoelectric converting layer accompanying the irradiation of the radiation X onto the electronic cassette 32, are accumulated in the storage capacitors 68 of the individual pixel portions 74. Due thereto, the image information, that is carried by the radiation X irradiated on the electronic cassette 32, is converted into charge information and is held at the radiation detector 60.

Plural gate lines 76, that extend in a given direction (the row direction) and are for turning the TFTs 70 of the individual pixel portions 74 on and off, and plural data lines 78, that extend in a direction (the column direction) orthogonal to the gate lines 76 and are for reading-out the accumulated charges from the storage capacitors 68 via the TFTs 70 that have been turned on, are provided at the TFT active matrix substrate 66. The individual gate lines 76 are connected to a gate line driver 80 (corresponding to a generation unit), and the individual data lines 78 are connected to a signal processing unit 82 (corresponding to a generation unit). When charges are accumulated in the storage capacitors 68 of the individual pixel portions 74, the TFTs 70 of the individual pixel portions 74 are turned on in order in units of rows by signals supplied from the gate line driver 80 via the gate lines 76, and the charges, that are accumulated in the storage capacitors 68 of the pixel portions 74 whose TFTs 70 have been turned on, are transferred through the data lines 78 as charge signals and are inputted to the signal processing unit 82. Accordingly, the charges, that are accumulated in the storage capacitors 68 of the individual pixel portions 74, are read-out in order in units of rows.

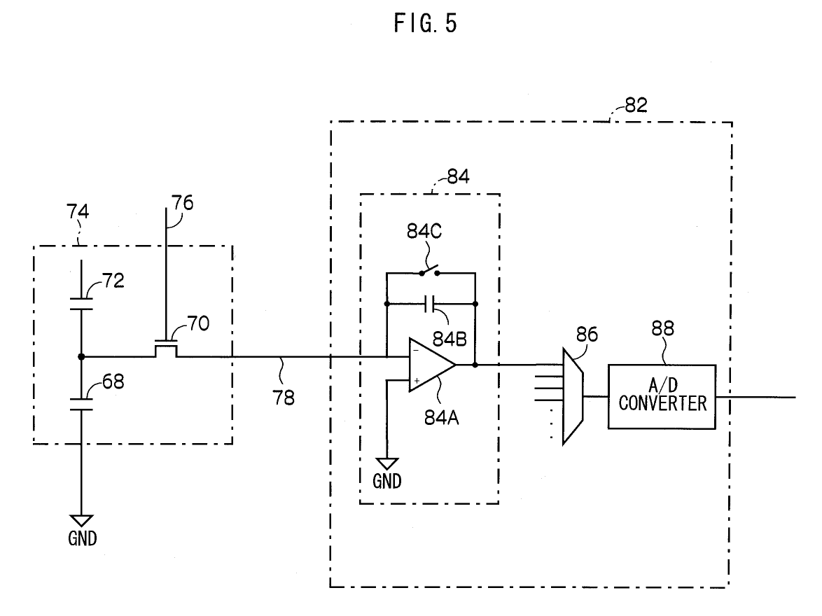

An equivalent circuit diagram that focuses on one pixel portion of the radiation detector 60 relating to the present exemplary embodiment is shown in FIG. 5.

The source of the TFT 70 is connected to the data line 78, and the data line 78 is connected to the signal processing unit 82. The drain of the TFT 70 is connected to the storage capacitor 68 and the photoelectric converting portion 72, and the gate of the TFT 70 is connected to the gate line 76.

The signal processing unit 82 has a sample holding circuit 84 for each of the individual data lines 78. The charge signals transferred through the individual data lines 78 are held by the sample holding circuits 84. The sample holding circuit 84 is structured to include an operational amplifier 84A and a capacitor 84B, and converts charge signals into analog voltage. A switch 84C, that serves as a resetting circuit that shorts both electrodes of the capacitor 84B and discharges the charges accumulated at the capacitor 84B, is provided at the sample holding circuit 84.

A multiplexer 86 and an A/D converter 88 are connected in that order to the output sides of the sample holding circuits 84. The charge signals held in the individual sample holding circuits are converted into analog voltages, are inputted in order (serially) to the multiplexer 86, and are converted into digital image information by the A/D converter 88.

A line memory 90 is connected to the signal processing unit 82 (see FIG. 4). The image information outputted from the A/D converter 88 of the signal processing unit 82 is stored in order in the line memory 90. The line memory 90 has a storage capacity that can store a predetermined number of lines of image information expressing a radiographic image. Each time reading-out of the charges of one line is carried out line-by-line, the image information of the read-out one line is successively stored in the line memory 90.

The line memory 90 is connected to a cassette controller 92 that controls the overall operation of the electronic cassette 32. The cassette controller 92 is realized by a microcomputer, and an optical communication controller 94 is connected thereto. The optical communication controller 94 is connected to the connection terminal 32A, and controls the transfer of various types of information between the electronic cassette 32 and an external device that is connected via the connection terminal 32A. The transmission and reception of various types of information between the cassette controller 92 and the external device via the optical communication controller 94 is possible. The cassette controller 92 stores image capturing control information, that will be described later and that is received from the external device, and starts reading-out of the charges on the basis of this information.

A power source unit 96 is provided at the electronic cassette 32. The above-described various types of circuits and respective elements (the gate line driver 80, the signal processing unit 82, the line memory 90, the optical communication controller 94, and the microcomputer that functions as the cassette controller 92) are operated by electric power supplied from the power source unit 96. The power source unit 96 incorporates therein a battery (a chargeable secondary battery) and supplies electric power to the various types of circuits and elements from the charged battery, so that the portability of the electronic cassette 32 is not adversely affected.

The console 42 is structured as a server computer, and has a display 100, that displays operation menus, captured radiographic images and the like, and an operation panel 102 that is structured to include plural keys and by which various types of information and operating instructions are inputted.

The console 42 relating to the present exemplary embodiment includes: a CPU 104 (corresponding to an acquisition unit, a judgment unit and a controller) that governs the operations of the overall device; a ROM 106 in which various types of programs including control programs and the like are stored in advance; a RAM 108 that temporarily stores various types of data; an HDD 110 that stores and holds various types of data; a display driver 112 that controls the display of various types of information on the display 100 (corresponding to a warning unit); an operation input detection unit 114 that detects the operated state of the operation panel 102; a communication interface (I/F) unit 116 that is connected to the connection terminal 42A and carries out transmission and reception of various types of information, such as exposure conditions and state information of the image capturing device 34 and the like that will be described later, with the image capturing device 34 via the connection terminal 42A and the communication cable 35; an optical communication controller 118 that is connected to the connection terminal 42B and carries out transmission and reception of various types of information, such as image capturing control information and image information and the like, with the electronic cassette 32 via the connection terminal 42B and the communication cable 43; and an image signal output unit 120 that is connected to the connection terminal 42C and outputs image signals to the display device 36 via the connection terminal 42C and the display cable 37.

The CPU 104, the ROM 106, the RAM 108, the HDD 110 (corresponding to a memory), the display driver 112, the operation input detection unit 114, the communication I/F unit 116, the optical communication controller 118 and the image signal output unit 120 are connected to one another via a system bus BUS. Accordingly, the CPU 104 can access the ROM 106, the RAM 108 and the HDD 110, and can carry out control of display of various types of information on the display 100 via the display driver 112, control of transmission and reception of various types of information with the image capturing device 34 via the communication I/F unit 116, control of transmission and reception of various types of information with the electronic cassette 32 via the optical communication controller 118, and control of the image that is displayed at the display device 36 via the image signal output unit 120. The CPU 104 can grasp the operated state of the operation panel 102 by a user via the operation input detection unit 114.

The image capturing device 34 has: a radiation source 130 that outputs the radiation X; a communication I/F unit 132 that transmits and receives various types of information, such as exposure conditions and state information of the image capturing device 34 and the like, with the console 42; and a radiation source controller 134 that controls the radiation source 130 on the basis of received exposure conditions. The radiation source controller 134 also is realized by a microcomputer, and stores the received exposure conditions, and causes the radiation X to be irradiated from the radiation source 130 on the basis of the stored exposure conditions.

The display device 36 has a display unit 36A that displays images expressed by received image signals.

The first exemplary embodiment carries out visible display by using LCDs (Liquid Crystal Displays) as the display unit 36A and the display 100, but is not limited to the same. Visible display may be carried out by using other displays such as organic EL displays, CRT displays or the like as the display unit 36A and the display 100.

The overall operation of the RIS 10 relating to the first exemplary embodiment will be briefly described.

The input terminal 12 (see FIG. 1) receives an image capturing request, that includes environment information, from the doctor 26 or radiology technician. The image capturing request designates the environment in which the electronic cassette 32 is used, the image capturing date and time, and the image capturing conditions (the region that is image captured, the angle and number of shots, the tube voltage, tube current and irradiation time for irradiating the radiation X, the size and sensitivity of the electronic cassette 32, and the like).

The input terminal 12 informs the RIS server 14 of the contents of the received image capturing request. The RIS server 14 stores, in the database 28, the contents of the image capturing request notified from the input terminal 12.

By accessing the RIS server 14, the console 42 acquires the contents of the image capturing request and the environment information associated therewith from the RIS server 14, and displays the contents of the image capturing request on the display 100 (see FIG. 2 and FIG. 4).

The doctor 26 or the radiology technician starts image capturing of radiographic images on the basis of the contents of the image capturing request that are displayed on the display 100.

For example, as shown in FIG. 2, in a case of carrying out image capturing of radiographic images of an affected part of the patient 30 who is lying on the operating table 46, the doctor 26 or the radiology technician places the electronic cassette 32 between the operating table 46 and the portion to be treated of the patient 30 in accordance with the region and angle of image capturing, and places the image capturing device 34 above the portion to be treated. The doctor 26 or the radiology technician carries out, at the operation panel 102 of the console 42, an exposure condition designating operation that designates the exposure conditions such as the tube voltage, the tube current, the irradiation time and the like at the time of irradiating the radiation X, in accordance with the region to be image captured of the patient 30 and the image capturing conditions. When exposure preparations of the image capturing device 34 are completed, the doctor 26 or the radiology technician carries out, at the operation panel 102 of the console 42, an image capturing instructing operation that instructs image capturing.

The operation of the image capturing system 18 relating to the first exemplary embodiment will be described in detail.

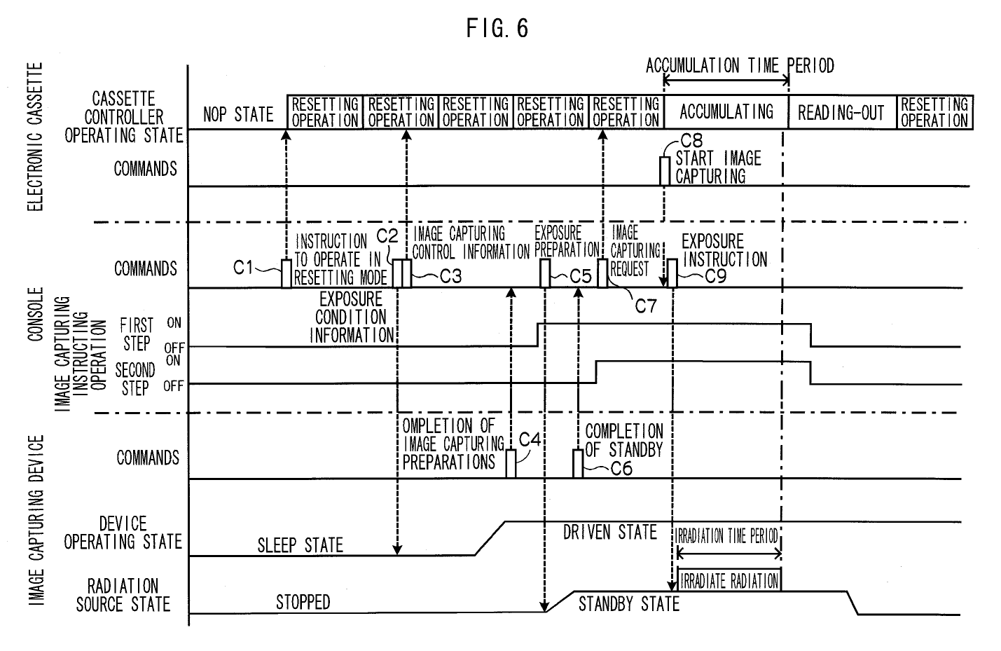

A timing chart showing the flow of operations at the time of image capturing a radiographic image by the image capturing system 18 is shown in FIG. 6.

In the state in which the power source of the electronic cassette 32 is turned on (the start-up state), the operation mode of the electronic cassette 32 is in a non-operating state (NOP state) that is an initial state, and the electronic cassette 32 operates on the basis of instruction information that is received from the console 42 via the communication cable 43.

When the power source of the electronic cassette 32 is in an on state, even if the radiation X is not being irradiated, at the radiation detector 60 (see FIG. 4) that is incorporated in the electronic cassette 32, charges are accumulated in the respective storage capacitors 68 due to dark current or the like. Therefore, when the operation mode is in the non-operating state, the cassette controller 92 is outputting an instruction signal that instructs resetting to the signal processing unit 82. When the instruction signal that instructs resetting is inputted to the signal processing unit 82, the switches 84C (see FIG. 5) turn on, and the both electrodes of the capacitors 84B are shorted. Due to the both electrodes of the capacitors 84B being shorted in this way, the charges that are accumulated unnecessarily in the capacitors 84B are discharged.

When the electronic cassette 32 is connected to the console 42 by the communication cable 43, the console 42 transmits instruction information C1, that instructs operation in the resetting mode, to the electronic cassette 32 via the communication cable 43.

At the cassette controller 92, when the instruction information C1 that instructs operation in the resetting mode is received, the operation mode moves on to the resetting mode, the gate line driver 80 is controlled such that on signals are outputted from the gate line driver 80 to the respective gate lines 76 in order and line-by-line, and the respective TFTs 36 that are connected to the respective gate lines 76 are turned on in order and line-by-line. Due thereto, the charges that are accumulated in the respective storage capacitors 68 flow-out to the respective data lines 78 as charge signals in order and line-by-line. During the time period when the operation mode is the resetting mode, the cassette controller 92 repeats the resetting operation in which on signals are made to be outputted to the respective gate lines 76 in order and line-by-line, and the charges of one frame that are accumulated in the respective storage capacitors 68 are reset.

When an exposure condition designating operation is carried out with respect to the operation panel 102, the console 42 transmits exposure condition information C2, such as the tube voltage, the tube current, the irradiation time and the like that are designated by the exposure condition designating operation, to the image capturing device 34 via the communication cable 35. At the time of capturing of a radiographic image, the console 42 transmits image capturing control information C3, such as the accumulating time for accumulating charges in the respective storage capacitors 68 of the radiation detector 60 and the like, to the electronic cassette 32 via the communication cable 43.

At the image capturing device 34, when the power source is turned on and a predetermined initial start-up operation is completed, the operating state of the image capturing device 34 becomes a sleep state, and the image capturing device 34 stands-by. When the exposure condition information C2 is received, the image capturing device 34 stores the received exposure condition information, and the operating state moves on to a driven state. When the operating state returns to the driven state, the image capturing device 34 transmits information C4, that expresses completion of image capturing preparations, to the console 42 via the communication cable 35.

When the image capturing control information C3 is received, the cassette controller 92 of the electronic cassette 32 stores the received image capturing control information.

When the information C4 expressing completion of the image capturing preparations is received, the console 42 displays the fact that image capturing preparations have been completed on the display 100, and an image capturing instructing operation that instructs image capturing can be carried out with respect to the operation panel 102. In the image capturing system 18 relating to the present exemplary embodiment, the image capturing instructing operation with respect to the operation panel 102 is a two-step operation. Capturing of a radiographic image is carried out by carrying out the image capturing instructing operation of the second step after the image capturing instructing operation of the first step with respect to the operation panel 102. In this two-step image capturing instructing operation, for example, two buttons of the operation panel 102 may be depressed in order, or, for example, a single button may be depressed halfway and then fully depressed.

When the image capturing instructing operation of the first step is carried out on the operation panel 102, the console 42 transmits instruction information C5, that instructs preparation for exposure, to the image capturing device 34 via the communication cable 35.

When the instruction information C5 that instructs preparation for exposure is received, the image capturing device 34 carries out standby of the radiation source 130 so that exposure will be carried out at the tube voltage and the tube current shown by the exposure condition information that was stored immediately before. When standby of the radiation source 130 is completed, the image capturing device 34 transmits information C6 that expresses completion of standby to the console 42 via the communication cable 35.

When the console 42 receives the information C6 expressing completion of standby, the image capturing instructing operation of the second step becomes possible. When the image capturing instructing operation of the second step is carried out on the operation panel 102, the console 42 transmits instruction information C7 that requests image capturing to the electronic cassette 32 via the communication cable 43.

When the instruction information C7 requesting image capturing is received, the cassette controller 92 carries out the resetting operation until the resetting operation of one frame is completed. After the resetting operation of one frame is completed, the cassette controller 92 transmits instructing operation C8 that instructs starting of image capturing to the console 42 via the communication cable 43, and moves the operation mode onto the image capturing mode.

When the instruction information C8 instructing starting of image capturing is received, the console 42 transmits instruction information C9 that instructs exposure to the image capturing device 34 via the communication cable 43.

When the instruction information C9 instructing exposure is received, the image capturing device 34 irradiates the radiation X from the radiation source 130 for the irradiation time expressed by the exposure condition information that was stored immediately before.

The radiation X irradiated from the radiation source 130 is transmitted through the patient 30, and thereafter, reaches the electronic cassette 32. Due thereto, charges, that correspond to the radiation amount of the irradiated radiation X, are accumulated in the storage capacitors 68 of the respective pixel portions 74 of the radiation detector 60 incorporated in the electronic cassette 32.

After transmitting the instruction information C8 that instructs starting of image capturing, the cassette controller 92 stands-by for the accumulating time that is stated by the image capturing control information stored immediately before, and thereafter, controls the gate line driver 80 such that on signals are outputted from the gate line driver 80 to the respective gate lines 76 in order and line-by-line, and the respective TFTs 36 connected to the respective gate lines 76 are turned on in order and line-by-line. Due thereto, the charges that are accumulated in the respective storage capacitors 68 flow-out to the respective data lines 78 as charge signals in order and line-by-line. The charge signals, that flow-out to the respective data lines 78, are inputted to the individual sample holding circuits 84 and converted into voltage signals, and the converted voltage signals are inputted in order (serially) to the multiplexer, are converted into digital image information by the A/D converter, and are stored in the line memory 90.

The console 42 transmits image information transfer request signals line-by-line to the electronic cassette 32 via the communication cable 43. Each time an image information transfer request signal is received, the cassette controller 92 converts one line of the image information stored in the line memory 90 into serial data, and transmits it to the console 42 via the communication cable 43. The transfer of image information of one frame may be carried out by counting, at the console 42, the number of lines that have been transferred, and stopping the transmission of the image information transfer request signals when the count value reaches the number of lines of one frame. Or, the cassette controller 92 may lastly transmit transfer completion information expressing the completion of transfer of the image information of one frame, and when the console 42 receives the transfer completion information, the console 42 may stop the transmission of the image information transfer request signals.

At the cassette controller 92, when transfer of the image information of one frame has ended, the operating mode moves on to the resetting mode. Here, it is assumed that continuous image capturing is not carried out and that the operation mode moves on to the resetting mode. However, continuous image capturing may be carried out.

The console 42 carries out predetermined image processing on the image information of one frame, and stores the image information after the image processing in the HDD 110 in a state of being associated with the patient information of the patient 30. The console 42 outputs, to the display device 36, image signals that express the radiographic image after the image processing, and causes the radiographic image to be displayed on the display unit 36A of the display device 36. The doctor 26 performs the surgery while confirming the radiographic image displayed on the display unit 36A.

In a case in which the communication cable can be attached and detached as in the present exemplary embodiment, if the cable becomes disconnected one time, the connected state between the connection terminal and the communication cable becomes unstable, and there are cases in which it becomes easy for cable disconnection to arise.

Thus, in the present exemplary embodiment, the bit error rate (BER) is detected as information expressing the connected state of the connection terminal 32A and the communication cable 43. The bit error rate is the probability that a bit, that is different than transmitted data, is contained in received data at the time of carrying out transmission and reception of digital data.

In the present exemplary embodiment, the same data for inspection that is determined in advance is stored in the cassette controller 92 of the electronic cassette 32 and in the ROM 106 of the console 42. At the time of carrying out transmission and reception of image information, the bit error rate is detected by executing the processings of a connected state detecting processing program at the console 42.

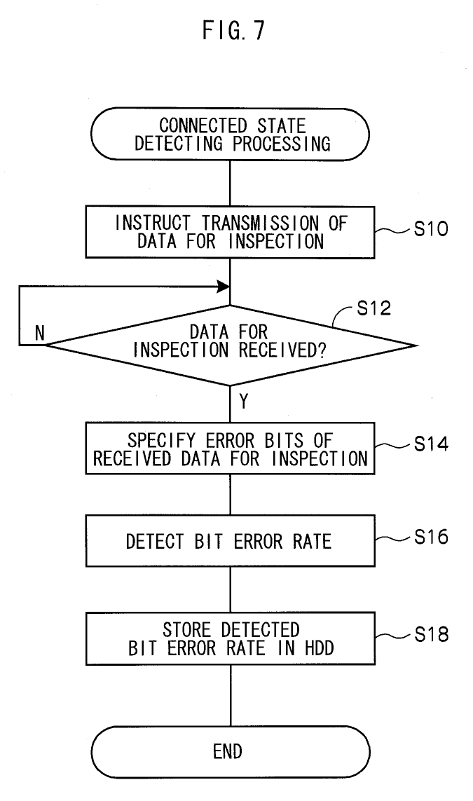

A flowchart showing the flow of the processings of the connected state detecting processing program that is executed by the CPU 104 at the time when transfer of image information is carried out, is shown in FIG. 7. This program is stored in advance in a predetermined region of the ROM 106.

In step S10, instruction information, that instructs transmission of the predetermined data for inspection, is transmitted to the electronic cassette 32 via the communication cable 43.

When the instruction information that instructs transmission of the data for inspection is received, the electronic cassette 32 transmits the data for inspection to the console 42 via the communication cable 43.

In step S12, waiting for reception of the data for inspection is carried out. In step S14, the received data for inspection is compared with the data for inspection that is stored in advance, and the error bits are specified. In step S16, the bit error rate is detected by determining the proportion of the number of bits that are error bits with respect to the number of bits of the data for inspection.

In step S18, the detected bit error rate is stored in the HDD 110, and processing ends. In the present exemplary embodiment, a predetermined number of the detected bit error rates are stored in order from the most recent detection timing, as history information that expresses the history of the connected states in the past.

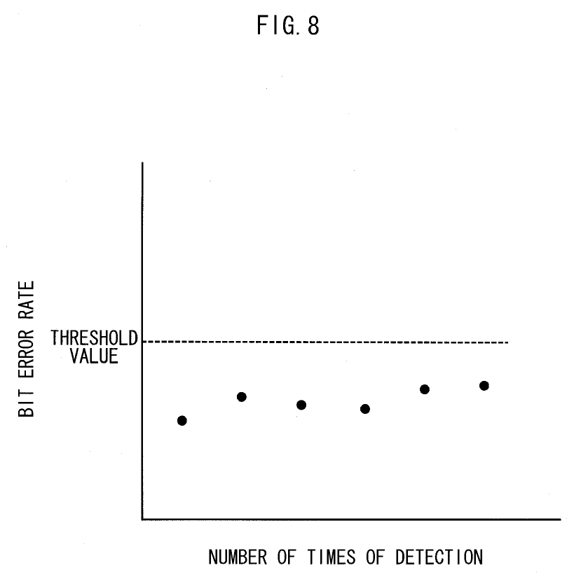

A graph showing an example of changes in the detected bit error rate is shown in FIG. 8.

The bit error rate has the trend that the value thereof increases as the connected state between the connection terminal 32A and the communication cable 43 worsens.

In the present exemplary embodiment, the bit error rate, in a case in which the connected state between the connection terminal 32A and the communication cable 43 has deteriorated and has become unsuitable for transfer of image information, is determined empirically and is stored in the ROM 106 of the console 42 as a threshold value. By executing the processings of a transfer error occurrence predicting program at the console 42 at a predetermined timing of the step of preparing for image capturing of a radiographic image, it is judged whether or not the communication cable 43 is unsuitable for transfer of image information. The aforementioned predetermined timing may be, for example, the time when the power source of the console 42 is turned on, or the time when the console 42 acquires information, such as the contents of the image capturing request and the like, from the RIS server 14. In a case in which the image capturing system 18 carries out capturing of radiographic images in an image capturing room, a sensor may be provided at the door through which patients enter the image capturing room, and the predetermined timing may be the time when the sensor detects the entry of the patient into the image capturing room. In a case in which the image capturing room and the technician room are separate, a sensor may be provided at the door between the image capturing room and the technician room, and the predetermined timing may be the time when the sensor detects the entry of the technician into the image capturing room.

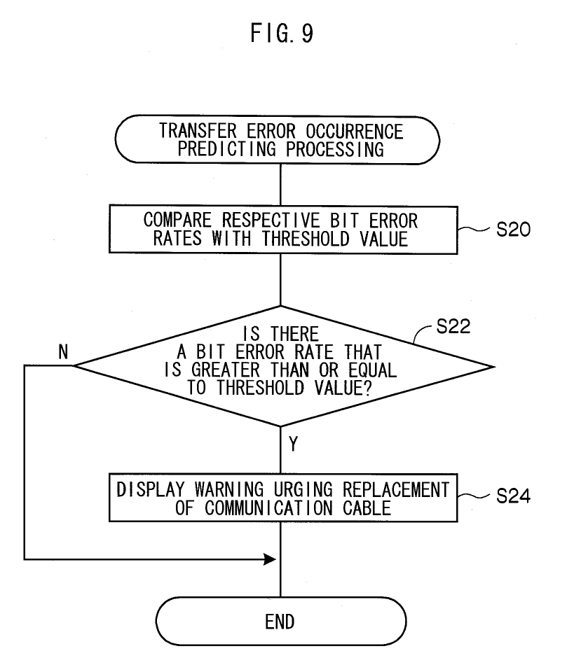

A flowchart, that shows the flow of the processings of the transfer error occurrence predicting processing program that is executed by the CPU 104 at a predetermined timing of the stage of preparing for capturing of a radiographic image, is shown in FIG. 9. This program is stored in advance in a predetermined region of the ROM 106.

In step S20, the respective bit error rates that are stored in the HDD 110 as history information are compared with the aforementioned threshold value.

In step S22, it is judged whether or not there is a bit error rate that is greater than or equal to the threshold value. If this judgment is affirmative, the routine moves on to step S24, whereas if the judgment is negative, processing ends.

In step S24, a warning that urges replacement of the communication cable 43 is displayed for a predetermined time period on the display 100, and processing ends.

In a case in which the warning that urges replacement of the communication cable 43 is displayed on the display 100, the doctor 26 or the radiology technician replaces the communication cable 43 with a new one. Due thereto, the connected state between the connection terminal 32A and the communication cable 43 is stable, and image information can be transferred stably. Therefore, the radiographic image can be captured smoothly.

When the doctor 26 or the radiology technician replaces the communication cable 43 with a new one, he/she carries out a predetermined erasing operation with respect to the operation panel 102 so as to erase the history information stored in the HDD 110. Due thereto, because the history information stored in the HDD 110 is erased, the giving of a warning on the basis of the history information of the old communication cable 43 before replacement can be prevented at the time of using the new communication cable 43.

As described above, in accordance with the first exemplary embodiment, history information, that expresses the history of the past connected states between the connection terminal 32A of the electronic cassette 32 and the communication cable 43 is acquired. In a case in which it is judged, on the basis of the acquired history information, whether or not the communication cable 43 connected to the connection terminal 32A is unsuitable for transfer of image information, a warning is given. Radiographic images can thereby be captured smoothly.

### Second Exemplary Embodiment

A second exemplary embodiment of the present invention will be described.

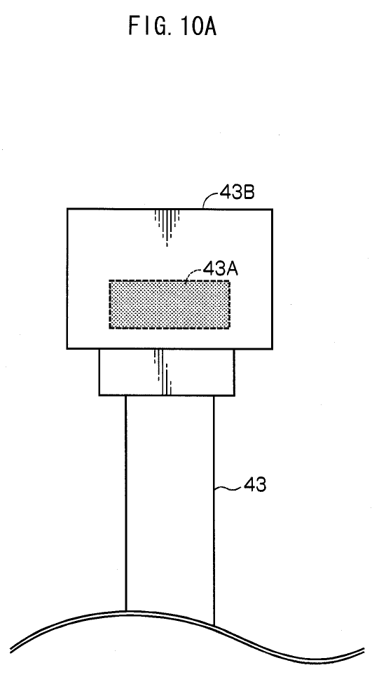

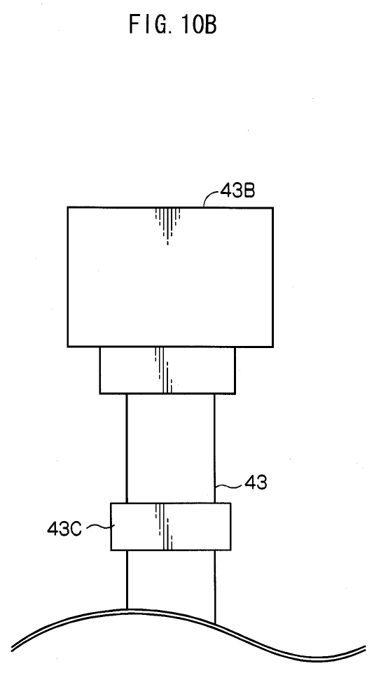

A plurality of the communication cables 43 relating to the second exemplary embodiment are readied. Memories 43A, in which is stored identification information for identifying the cable, are added to both terminals 43B (corresponding to a generation unit) of each of the communication cables 43. In the present exemplary embodiment, as the memory 43A, a chip that can be read by wireless communication such as RFID (Radio Frequency Identification) or the like is embedded. The region of the terminal 43B where the memory 43A is embedded is shown in FIG. 10A. For example, in a case in which the shapes of the terminals 43B at the both ends of the communication cable 43 differ at the side that is connected to the console 42 and the side that is connected to the electronic cassette 32, and the terminal 43B that is connected to the console 42 is specified, it is possible to embed the memory 43A only in the terminal 43B at the side of the communication cable 43 that is connected to the console 42.

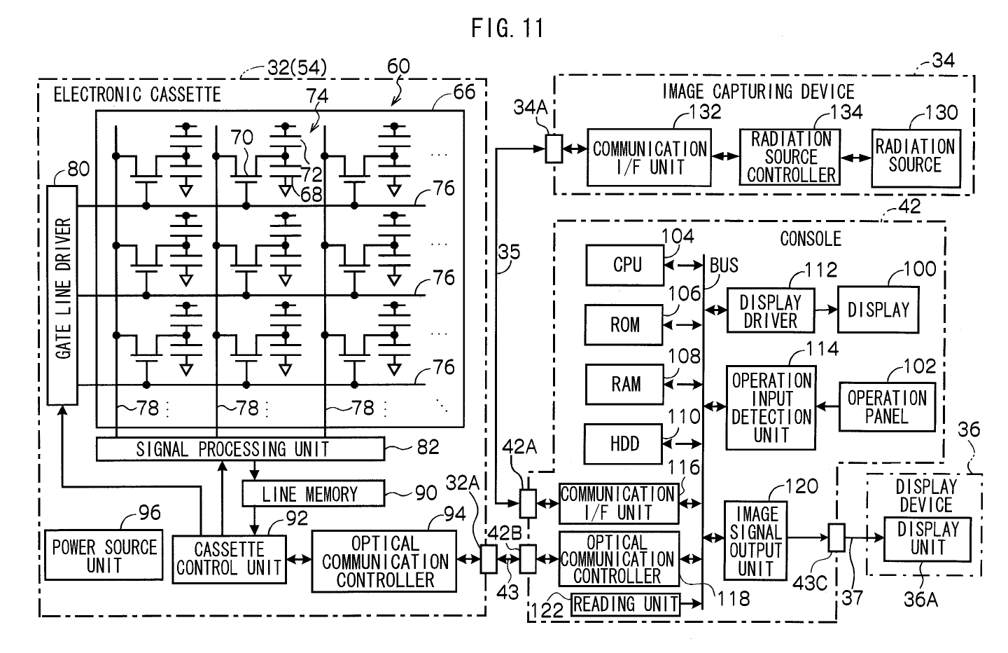

A block diagram showing the detailed structure of the radiographic image capturing system 18 relating to the second exemplary embodiment is shown in FIG. 11. Portions that are the same as those of the above-described first exemplary embodiment (FIG. 4) are denoted by the same reference numerals and description thereof is omitted.

In the console 42 relating to the second exemplary embodiment, a reading unit 122 (corresponding to a specifying unit) is provided in a vicinity of the connection terminal 42B. At the time when the communication cable 43 is connected to the connection terminal 42B, the reading unit 122 reads the identification information of the memory 43A that is added to the communication cable 43 connected to the connection terminal 42B. The reading unit 122 is connected to the system bus BUS, and outputs the read identification information to the system bus BUS. In this way, the CPU 104 can know the identification information read by the reading unit 122.

The CPU 104 is at all times monitoring the identification information inputted from the reading unit 122, and, on the basis of the presence/absence of input of identification information, judges whether or not the communication cable 43 is connected to the connection terminal 42B. In a case in which identification information is inputted from the reading unit 122, the CPU 104 specifies that the communication cable 43 of that identification information is the cable that is connected to the connection terminal 42B.

Operation of the image capturing system 18 relating to the second exemplary embodiment will be described.

In the image capturing system 18 relating to the second exemplary embodiment, a plurality of the communication cables 43 are readied, and all of the communication cables 43 can be used. There are cases in which, with a specific communication cable 43, it is easy for disconnection of the cable to occur.

Thus, at the time of carrying out transmission and reception of image data, the console 42 relating to the second exemplary embodiment executes the following connected state detecting processing program and carries out bit error rate detection, and stores the detected bit error rate in the HDD 110 for each communication cable 43.

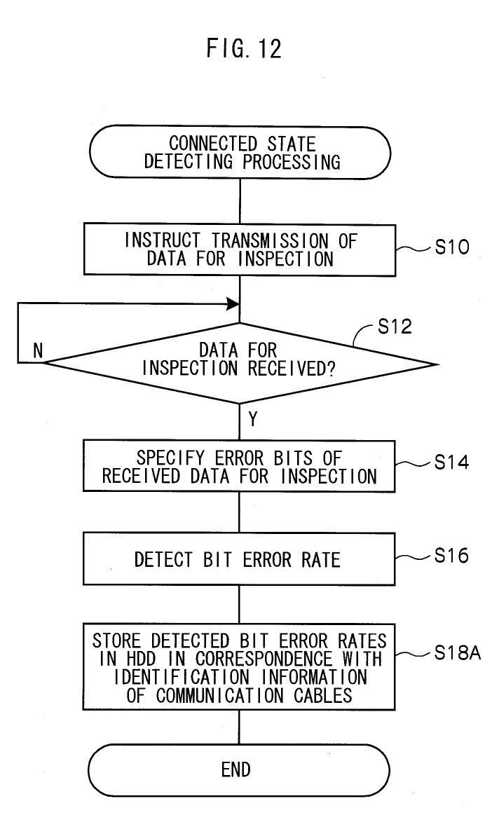

A flowchart showing the flow of processings of the connected state detecting processing program relating to the second exemplary embodiment is shown in FIG. 12. Portions that are the same as those of the above-described first exemplary embodiment (FIG. 7) are denoted by the same reference numerals, and description thereof is omitted.

In step S18A, a predetermined number of the detected bit error rates are stored in the HDD 110 in correspondence with the identification information of the communication cables 43 and in order from the most recent detection timing per identification information, as history information that expresses the history of the connected states in the past.

In this way, the history information of each of the communication cables 43 is stored in the HDD 110.

At the time when the communication cable 43 is connected to the connection terminal 42B, the console 42 relating to the second exemplary embodiment executes the following transfer error occurrence predicting program, and judges whether or not the communication cable 43 connected to the connection terminal 42B is unsuitable for transfer of image information.

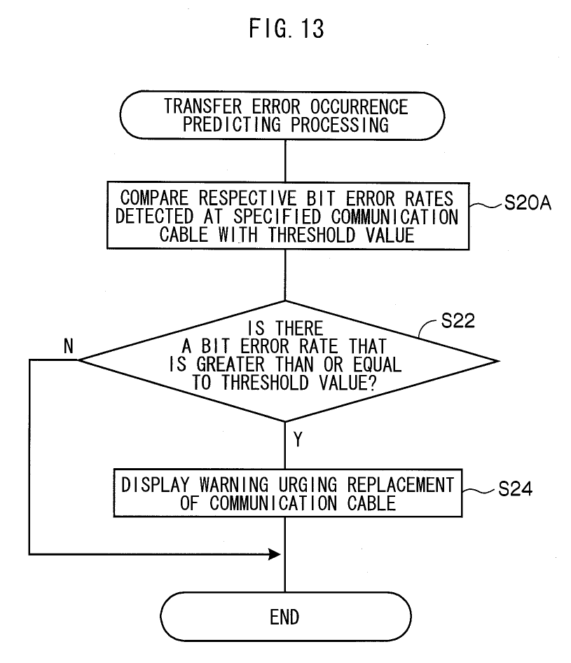

A flowchart, that shows the flow of the processings of the transfer error occurrence predicting processing program relating to the second exemplary embodiment, is shown in FIG. 13. Note that portions that are the same as those of the above-described first exemplary embodiment (FIG. 9) are denoted by the same reference numerals and description thereof is omitted.

In step S20A, the respective bit error rates, that are stored in the HDD 110 as history information in correspondence with the identification information of the communication cable 43 that is connected to the connection terminal 42B, are compared with the aforementioned threshold value.

Due thereto, in a case in which the communication cable 43 that is connected to the connection terminal 32A is unsuitable for transfer of image information, a warning is given.

As described above, in accordance with the second exemplary embodiment, the communication cable 43 that is connected to the connection terminal 32A is specified, and it is judged whether or not the specified communication cable 43 is unsuitable for transfer of image information. In this way, even in cases in which plural communication cables 43 are used, warning can be given about the communication cable 43 that is unsuitable for transfer of the image information.

### Third Exemplary Embodiment

A third exemplary embodiment of the present invention will be described.

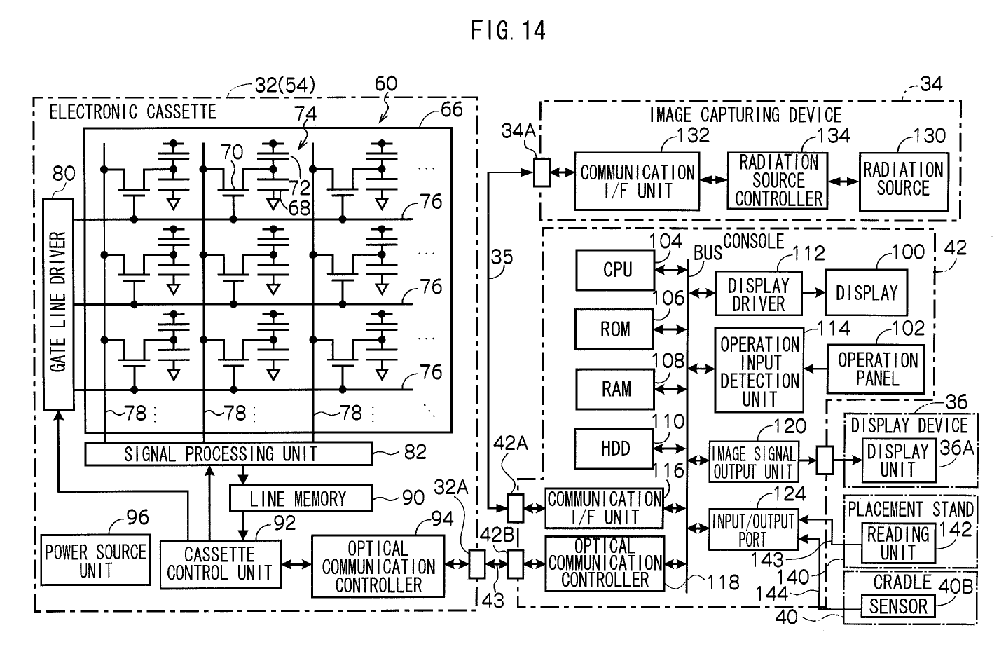

A block diagram showing the detailed structure of the radiographic image capturing system 18 relating to the third exemplary embodiment is shown in FIG. 14. Portions that are the same as those of the above-described first exemplary embodiment (FIG. 4) are denoted by the same reference numerals, and description thereof is omitted.

The image capturing system 18 relating to the third exemplary embodiment is provided with, in addition to the structures of the above-described first exemplary embodiment, a placement stand 140 on which the communication cables 43 are placed.

The console 42 has an input/output port 124 such as a USB (Universal Serial Bus) or the like. The input/output port 124 is connected to the system bus BUS. Inputted information of the input/output port 124 is outputted to the system bus BUS, and information, that is designated to be transferred through the system bus BUS, is outputted from the input/output port 124. The CPU 104 can grasp the various types of information that are inputted to the input/output port 124. The placement stand 140 is connected to the input/output port 124 via a communication cable 143. The cradle 40 is connected to the input/output port 124 via a communication cable 144.

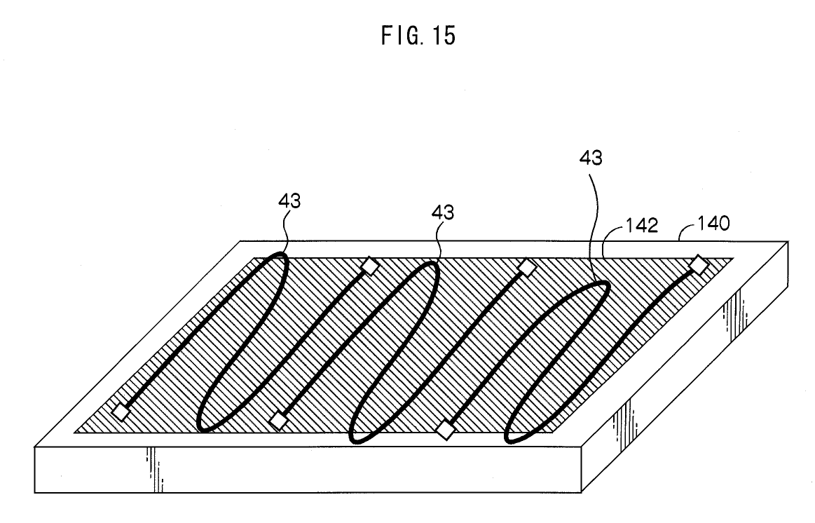

The structure of the placement stand 140 relating to the third exemplary embodiment is shown in FIG. 15.

The placement stand 140 is formed in the shape of a table, and plural communication cables 43 are placed on the top surface thereof.

In the same way as in the second exemplary embodiment, the memories 43A are embedded (see FIG. 10) in the terminals 43B of the communication cables 43 relating to the third exemplary embodiment.

A reading unit 142 (corresponding to a specifying unit), that reads the identification information stored in the memories 43A by wireless communication, is provided at the region of the top surface of the placement stand 140 at which region the communication cables 43 are placed. The reading unit 142 transmits, to the console 34, the identification information read from the memories 43A by wireless communication.

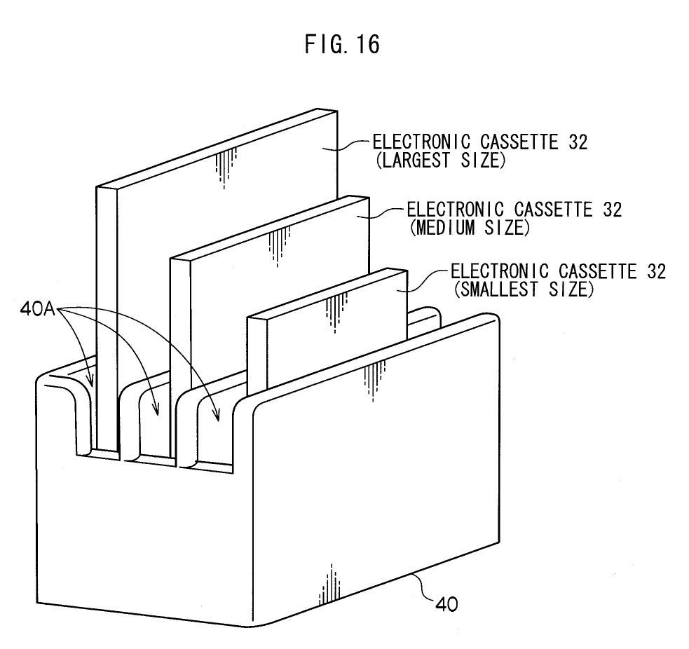

The structure of the cradle 40 relating to the third exemplary embodiment is shown in FIG. 16.

Plural accommodating portions 40A, in which plural electronic cassettes 32 can be accommodated individually, are formed in the cradle 40. In the image capturing system 18 relating to the third exemplary embodiment, three electronic cassettes 32 of different sizes that are a smallest size, a medium size and a largest size are readied. Three of the accommodating portions 40A are formed in the cradle 40, and the sizes of the electronic cassettes that can be accommodated respectively therein are fixed.

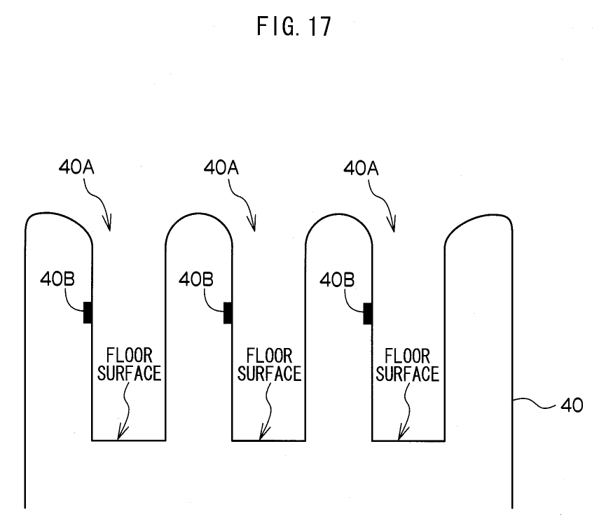

As show in FIG. 17, a sensor 40B is provided in each of the accommodating portions 40A of the cradle 40. The sensor 40B has a light-emitting portion and a light-receiving portion. Due to light being illuminated from the light-emitting portion and reflected light being received at the light-receiving portion, the sensor 40B detects whether or not the electronic cassette 32 is accommodated in the accommodating portion 40A, and transmits detection information to the console 34. Instead of the sensors 40B, mechanical switches may be provided at the floor surface of the respective accommodating portions 40A and may detect whether or not the electronic cassettes 32 are accommodated.

The CPU 104 is at all times monitoring the identification information and the detection information inputted to the input/output port 124. In a case in which the inputted identification information decreases, the CPU 104 specifies the communication cable 43 of the decreased identification information as a cable that has been taken-out from the placement stand 140. On the basis of the inputted detection information, the CPU 104 specifies the electronic cassette 32 that is not accommodated in the accommodating portion 40A.

Operation of the image capturing system 18 relating to the third exemplary embodiment will be described.

In the image capturing system 18 relating to the third exemplary embodiment, plural electronic cassettes 32 are readied, plural communication cables 43 are readied, and they can be used in any combination of the electronic cassette 32 and the communication cable 43. There are cases in which it is easy for cable disconnection to occur with a specific combination of the electronic cassette 32 and the communication cable 43.

Thus, at the time of carrying out transmission and reception of image data, the console 42 relating to the third exemplary embodiment executes the following connected state detecting processing program, carries out bit error rate detection, and stores the detected bit error rate in the HDD 110 per combination of the electronic cassette 32 and the communication cable 43.

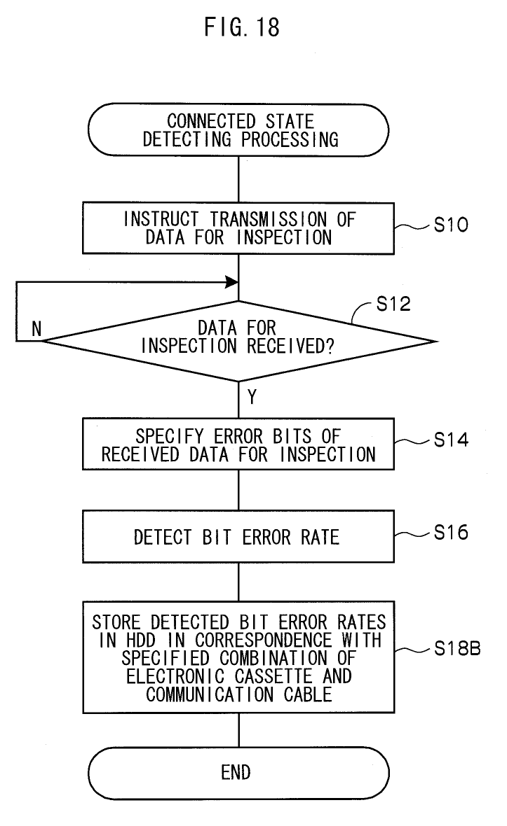

A flowchart showing the flow of processings of the connected state detecting processing program relating to the third exemplary embodiment is shown in FIG. 18. Portions that are the same as those of the first exemplary embodiment (FIG. 7) are denoted by the same reference numerals, and description thereof is omitted.

In step S18B, a predetermined number of the detected bit error rates are stored in the HDD 110 in correspondence with the specified combination of the electronic cassette 32 and the communication cable 43 and in order from the most recent detection timing per combination, as history information that expresses the history of the connected states in the past.

Due thereto, history information per combination of the electronic cassette 32 and the communication cable 43 is stored in the HDD 110.

At the time of specifying the electronic cassette 32 that has been taken-out from the cradle 40 and the communication cable 43 that has been taken-out from the placement stand 140, the console 42 relating to the third exemplary embodiment executes the following transfer error occurrence predicting program, and judges whether or not the specified combination of the electronic cassette 32 and the communication cable 43 is unsuitable for transfer of image information.

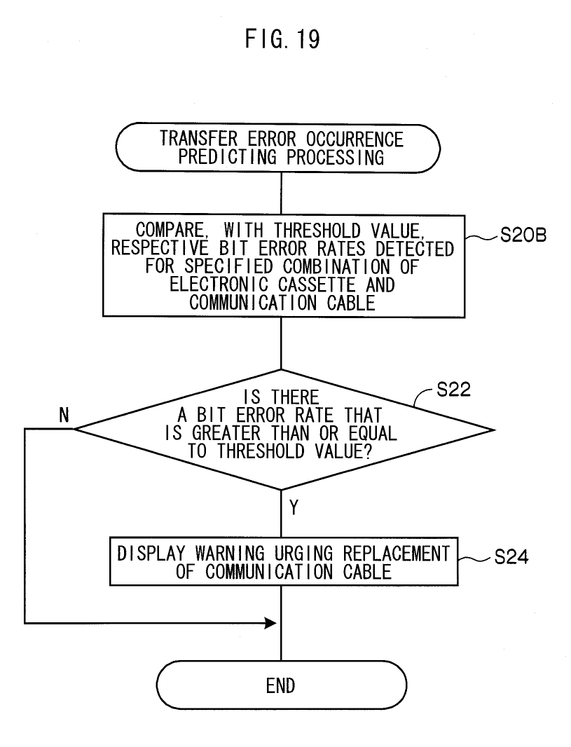

A flowchart showing the flow of the processings of the transfer error occurrence predicting processing program relating to the third exemplary embodiment is shown in FIG. 19. Portions that are the same as those of the first exemplary embodiment are denoted by the same reference numerals, and description thereof is omitted.

In step S20B, the respective bit error rates, that are stored as history information in the HDD 110 in correspondence with the specified combination of the electronic cassette 32 and the communication cable 43, are compared with the aforementioned threshold value.

Due thereto, if the combination of the electronic cassette 32 and the communication cable 43 is unsuitable for transfer of image information, a warning is given.

As described above, in accordance with the third exemplary embodiment, history information is stored in the HDD 110 per combination of the electronic cassette 32 and the communication cable 43, and a warning is given on the basis of the history information corresponding to the combination of the electronic cassette 32 and the communication cable 43. Due thereto, because the combination of the electronic cassette 32 and the communication cable 43 whose connected state has become unstable can be excluded, radiographic images can be captured smoothly.

The above respective exemplary embodiments describe cases in which the bit error rate is detected as information that expresses the connected state between the connection terminal 32A and the communication cable 43. However, the present invention is not limited to the same, and any information that expresses the quality of the communication at the time of transferring data may be used. For example, the number of resend requests at the time when data is transferred may be used. The number of resend requests tends to increase when the connected state between the connection terminal 32A and the communication cable 43 deteriorates. Therefore, the number of resend requests can be used in judging the connected state between the connection terminal 32A and the communication cable 43.

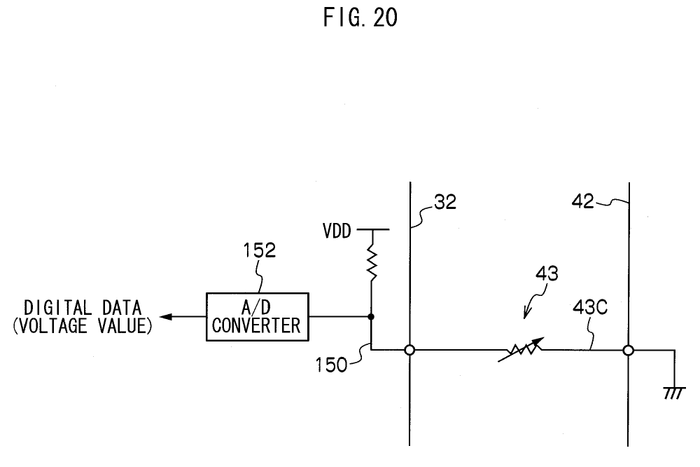

For example, in a case in which the communication cable 43 has a shield line for protecting the signal line, through which data is transferred, from noise, external damage and the like, the resistance value of the shield line may be measured. The resistance value of the shield line tends to increase when the connected state between the connection terminal 32A and the communication cable 43 worsens. Therefore, the resistance value of the shield line can be used in judging the connected state between the connection terminal 32A and the communication cable 43. An example of a measuring circuit that measures the resistance value of a shield line 43C of the communication cable 43 is shown in FIG. 20. In the case of the communication cable 43 that carries out optical communication, the shield line 43C can be considered to be a single line. Thus, for example, at the console 43, one end of the shield line 43C is connected to a ground line. At the electronic cassette 32, current flows to the other end of the shield line 43C via a line 150, and the voltage level of the line 150 is converted into digital data at an A/D converter 152 and detected. In this case, it suffices for the electronic cassette 32 to transmit the detected voltage level to the console 42. Note that the other end of the shield line 43C may be connected to a ground line at the electronic cassette 32, and the resistance value of the shield line 43C may be detected at the console 43. In this measuring circuit, when the resistance value of the shield line 43C increases, the voltage level of the line 150 also rises. Accordingly, by detecting the voltage level of the line 150, the resistance value of the shield line 43C can be determined.

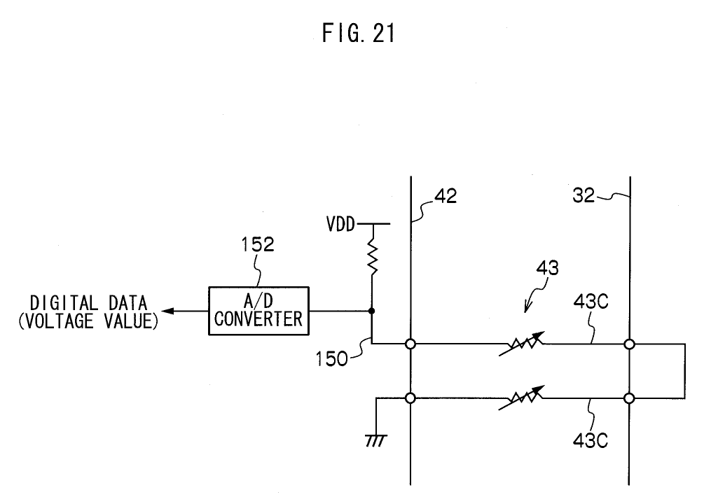

For example, in the case of using twisted pair lines as the communication cable 43, the shield lines 43C are also provided as a pair at the twisted pair lines. An example of a measuring circuit that measures the resistance values of the shield lines 43C of the communication cable 43 in a case in which a pair of the shield lines 43C are provided at the communication cable 43, is shown in FIG. 21. In this case, by forming a closed circuit by connecting one end sides of the pair of shield lines 43C, the resistance values of the pair of shield lines 43C can be detected at one time. In a case in which the communication cable 43 is provided with one of each of the shield line 43C and a signal line, for example, a switch that connects the shield line and the signal line may be provided at one end side, and, while the resistance value is measured, the switch may be turned on, and one end sides of the signal line and the shield line may be connected, and a closed circuit may be formed. When transfer of data is carried out at the signal line, the switch may be turned off and the signal line and the shield line disconnected.

The above respective exemplary embodiments describe cases in which the communication quality is detected as information that expresses the connected state between the connection terminal 32A and the communication cable 43, but the present invention is not limited to the same. For example, a mechanical switch or a sensor may be provided at the connection terminal 32A, and the physically joined state of the connection terminal 32A and the communication cable 43, that is detected by the mechanical switch or the sensor, may be detected.

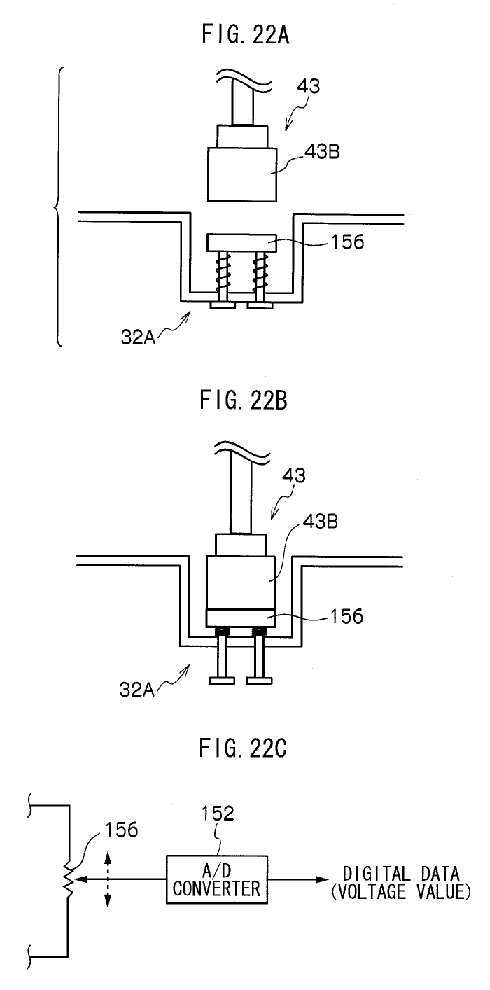

An example in which a mechanical switch 156 is provided at the connection terminal 32A is shown in FIG. 22A and FIG. 22B. FIG. 22A shows the state of the mechanical switch 156 in a case in which the communication cable 43 is not connected to the connection terminal 32A. FIG. 22B shows the state of the mechanical switch 156 in a case in which the communication cable 43 is connected to the connection terminal 32A. In a case of sensing the on, off of the mechanical switch 156, after the communication cable 43 is connected to the connection terminal 32A, the presence/absence of chattering of the mechanical switch 156 may be detected. For example, as shown in FIG. 22C, in a case in which the position of contact with a resistor 158 varies in accordance with the amount of insertion of the communication cable 43, and the mechanical switch 156 outputs an analog signal, that analog signal may be detected.

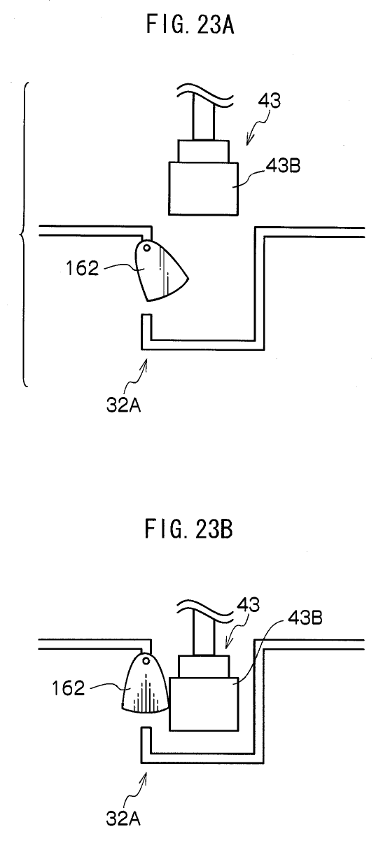

As another example of the mechanical switch, an example in which a mechanical switch 162, that swings in accordance with the amount of insertion of the communication cable 43, is shown in FIG. 23A and FIG. 23B. FIG. 23A shows the state of the mechanical switch 162 in a case in which the communication cable 43 is not connected to the connection terminal 32A. FIG. 23B shows the state of the mechanical switch 162 in a case in which the communication cable 43 is connected to the connection terminal 32A. This mechanical switch 162 also can be used in judging the connected state between the connection terminal 32A and the communication cable 43.

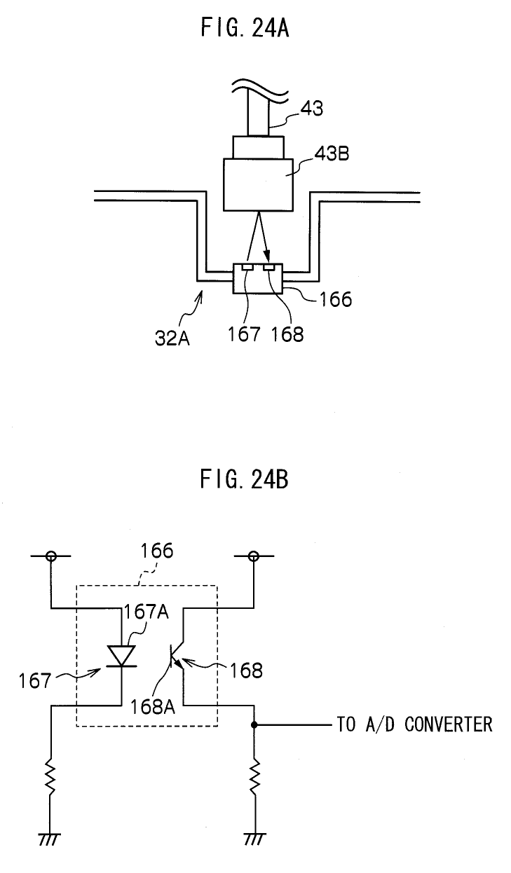

An example in which a reflection-type sensor 166 is provided as a sensor at the connection terminal 32A is shown in FIG. 24A. The sensor 166 illuminates light from a light-emitting portion 167, and receives the reflected light at a light-receiving portion 168. An equivalent circuit diagram of the sensor 166 is shown in FIG. 24B. The light-emitting portion 167 has a light-emitting diode 167A, and the light-receiving portion 168 has a photodiode 168A. By detecting the current or the voltage that flows via the photodiode 168A, the amount of insertion of the communication cable 43 can be detected.

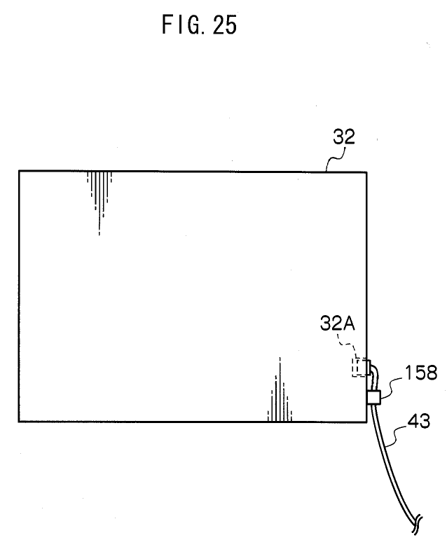

For example, as shown in FIG. 25, in a case in which the communication cable 43 that is connected to the connection terminal 32A is held by a holding member 158 provided at the electronic cassette 32, and the connection terminal 32A and the communication cable 43 are set in a connected state, a mechanical switch or a sensor may be provided at the holding member 158, and the held state of the communication cable 43 may be detected.

The above respective exemplary embodiments describe cases in which a warning is given to the doctor 26 or radiology technician by a warning being displayed on the display 100, but the present invention is not limited to the same. For example, sound output by using a sound reproducing device such as a speaker or the like may be carried out, or printed output may be carried out. Or, several of display of a warning on the display 100, audio output from a speaker, and printed output may be used in combination.

The above respective exemplary embodiments describe cases in which history information is acquired by detecting the connected state at the console 34 and storing the history information, that expresses the history of the connected state, at the console 34. However, the present invention is not limited to the same. For example, the connected state may be detected at the electronic cassette 32, and the results of detection may be transmitted to the console 34. For example, the history information may be stored in the electronic cassette 32 or in an external device. The threshold value as well may be stored in the electronic cassette 32 or in an external device.

Although the above respective exemplary embodiments describe cases in which the suitability of the communication cable 43 for transferring image information is judged on the basis of history information at the console 34, the present invention is not limited to the same. For example, judgment may be carried out at the electronic cassette 32. The warning may be carried out at the electronic cassette, or may be carried out at the console 34.

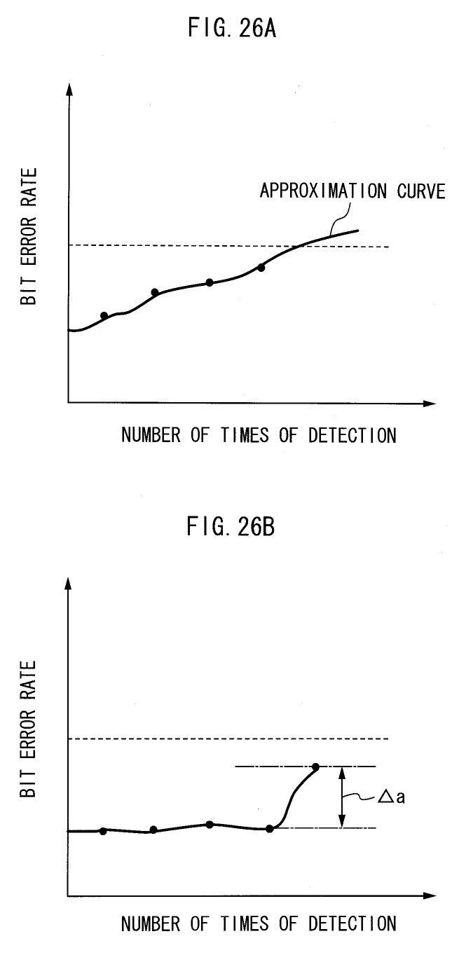

The above exemplary embodiments describe cases in which it is judged that the connected state between the connection terminal 32A and the communication cable 43 has worsened on the basis of whether or not there is a bit error rate that is greater than or equal to the threshold value among the bit error rates that are stored as the history information. However, the present invention is not limited to the same. For example, it may be judged that the connected state between the connection terminal 32A and the communication cable 43 has worsened in accordance with whether or not there are a predetermined number (e.g., two) or more bit error rates that are greater than or equal to the threshold value, or in accordance with whether or not it is greater than or equal to the average value or a predetermined value of the bit error rates that are stored as the history information. In a case in which worsening of the connected state is predicted, it may be judged that the connected state has worsened. For example, as shown in FIG. 26A, in a case in which the bit error rates stored as history information are smaller than the threshold value, an approximation curve (e.g., a spline curve) that passes smoothly through the respective points of the bit error rate is determined, and in a case in which it is predicted from the changes in the bit error rate that the threshold value will be exceeded, it may be judged that the connected state between the connection terminal 32A and the communication cable 43 has deteriorated. For example, as shown in FIG. 26B, in a case in which a change amount Δa of the respective points of the bit error rate is greater than or equal to a predetermined amount, it may be judged that the connected state has worsened. Namely, it suffices to determine in advance a condition that is unsuitable for stable transfer of image information, and to judge whether or not the bit error rates stored as the history information satisfy that condition.

The above second and third exemplary embodiments describe cases in which the identification information is known by the reading unit 122 or the reading unit 142 reading the memory that is added to the communication cable 43, but the present invention is not limited to the same. For example, the communication cable 43 may be specified by reading identification information 43C that is added to the communication cable 43 (see FIG. 10B).

The structure of the radiation information system 10 (see FIG. 1), the structure of the image capturing system 18 (see FIG. 2, FIG. 3, FIG. 4, FIG. 11 and FIG. 14), and the structure of the electronic cassette 32 (see FIG. 3 through FIG. 5) that are described in the above respective exemplary embodiments are examples, and can be changed in accordance with the situation and within a scope that does not deviate from the gist of the present invention.

The flow (see FIG. 6) of the operations at the time of capturing a radiographic image, that is described in the first exemplary embodiment, is also an example, and can be changed in accordance with the situation and within a scope that does not deviate from the gist of the present invention.

The flows (see FIG. 7, FIG. 9, FIG. 12, FIG. 13, FIG. 18, FIG. 19) of the processings of the programs described in the above respective exemplary embodiments are also examples. Unnecessary steps thereof may be deleted, new steps may be added thereto, or the order of the processings thereof may be rearranged within a scope that does not deviate from the gist of the present invention.

In accordance with a first aspect of the present invention, there is provided a warning device including: an acquisition unit acquiring history information expressing a history of past connected states between a communication cable and a connection terminal of a radiographic device that has a generation unit, that generates image information expressing a radiographic image expressed by irradiated radiation, and the connection terminal and that transfers generated image information via the communication cable connected to the connection terminal; a judgment unit judging, on the basis of the history information acquired by the acquisition unit, whether or not the communication cable that is connected to the connection terminal is unsuitable for transfer of the image information; and a controller controlling a warning unit such that a warning is given in a case in which the judgment unit judges that the communication cable connected to the connection terminal is unsuitable for transfer of the image information.

In accordance with the first aspect of the present invention, history information, that expresses a history of past connected states between a communication cable and a connection terminal of a radiographic device, is acquired. On the basis of the acquired history information, it is judged whether or not the communication cable that is connected to the connection terminal is unsuitable for transfer of image information. In a case in which it is judged that the communication cable connected to the connection terminal is unsuitable for transfer of the image information, a warning unit is controlled such that a warning is given. By replacing the communication cable in accordance with the warning, the connected state between the connection terminal and the communication cable is stable, and image information can be transferred stably. Therefore, radiographic images can be captured smoothly.

In accordance with a second aspect of the present invention, in the warning device of the first aspect, the warning device may further include a specifying unit that specifies, among a plurality of communication cables, a communication cable that is connected to the connection terminal, and the judgment unit may judge whether or not a communication cable, that is specified by the specifying unit, is unsuitable for transfer of the image information.

Due thereto, even if plural communication cables are used, warning can be given of a communication cable that is unsuitable for transfer of image information.

In accordance with a third aspect of the present invention, in the warning device of the second aspect, the specifying unit may specify the communication cable by reading identification information of the communication cable or identification information that is stored in a memory of the communication cable.

Due thereto, identification information of the communication cable can be acquired easily.

In accordance with a fourth aspect of the present invention, in the warning device of the first aspect, the warning device may further include a storage unit storing the history information that expresses the history of the past connected states between the connection terminal and the communication cable.

By storing the history information in the storage unit in this way, it can be appropriately judged whether or not the communication cable is unsuitable for transfer of image information.

In accordance with a fifth aspect of the present invention, in the warning device of the first aspect, the judgment unit may judge whether or not the communication cable is unsuitable for transfer of the image information by judging whether or not the history of the past connected states expressed by the history information satisfies a predetermined condition by which it is judged that the communication cable is unsuitable for transfer of the image information.

Due thereto, it can be appropriately judged whether or not the communication cable is unsuitable for transfer of image information.

In accordance with a sixth aspect of the present invention, in the warning device of the fifth aspect, the judgment unit may judge that the communication cable is unsuitable for transfer of the image information in a case in which deterioration of a connected state is predicted from the history of the past connected states expressed by the history information.

Due thereto, the communication cable can be replaced before the connected state deteriorates in earnest.

In accordance with a seventh aspect of the present invention, in warning device of the fifth aspect, the judgment unit may judge that the communication cable is unsuitable for transfer of the image information in a case in which a change of a connected state from the history of the past connected states expressed by the history information is greater than or equal to a predetermined amount.

Due thereto, the communication cable can be replaced at the time when the connected state between the connection terminal and the communication cable becomes unstable.

In accordance with an eighth aspect of the present invention, in the warning device of the first aspect, the history information may be at least one of information that expresses a history of physically joined states between the connection terminal and the communication cable that are detected by a mechanical switch or a sensor, information that expresses a history of communication quality at times when the communication cable is connected to the connection terminal and data is transferred, and information that expresses a history of held states of the communication cable at times when the communication cable is connected to the connection terminal and is held by a holding member provided at the radiographic device.

In accordance with a ninth aspect of the present invention, in the warning device of the first aspect, the judgment unit may carry out judging at a predetermined timing of a step of preparing for capturing of a radiographic image.

Due thereto, judgment is carried out at a predetermined timing of the step of preparing for image capturing, and a warning is given in a case in which the communication cable is unsuitable for transfer of image information. The connected state between the connection terminal and the communication cable at the time of capturing a radiographic image can thereby be prevented from becoming unstable.

In accordance with a twelfth aspect of the present invention, there is provided a computer readable medium storing a program causing a computer to execute a process for giving a warning, the process including: acquiring history information expressing a history of past connected states between a communication cable and a connection terminal of a radiographic device that has a generation unit, that generates image information expressing a radiographic image expressed by irradiated radiation, and the connection terminal and that transfers generated image information via the communication cable connected to the connection terminal; judging, on the basis of the acquired history information, whether or not the communication cable that is connected to the connection terminal is unsuitable for transfer of the image information; and giving a warning in a case in which it is judged that the communication cable connected to the connection terminal is unsuitable for transfer of the image information.

In accordance with the twelfth aspect, a computer is made to operate similarly to the warning device of the first aspect. Therefore, effects that are similar to those of the warning device can be obtained.

In this way, in accordance with the present invention, history information, that expresses a history of past connected states between a communication cable and a connection terminal of a radiographic device, is acquired. On the basis of the acquired history information, it is judged whether or not the communication cable that is connected to the connection terminal is unsuitable for transfer of image information. If it is judged that the communication cable that is connected to the connection terminal is unsuitable for transfer of the image information, the warning unit is controlled such that a warning is given. Therefore, radiographic images can be captured smoothly.

Embodiments of the present invention are described above, but the present invention is not limited to the embodiments as will be clear to those skilled in the art.

What is claimed is:

1. A warning device comprising:
an acquisition unit acquiring history information expressing a history of past connected states between a communication cable and a connection terminal of a radiographic device that has a generation unit, which generates image information expressing a radiographic image expressed by irradiated radiation, and that transfers generated image information via the communication cable connected to the connection terminal;
a judgment unit judging, on the basis of the history information acquired by the acquisition unit, whether or not the communication cable that is connected to the connection terminal is unsuitable for transfer of the image information; and
a controller controlling a warning unit such that a warning is given in a case in which the judgment unit judges that the communication cable connected to the connection terminal is unsuitable for transfer of the image information.

2. The warning device of claim 1, further comprising a specifying unit that specifies, among a plurality of communication cables, a communication cable that is connected to the connection terminal,
wherein the judgment unit judges whether or not a communication cable, that is specified by the specifying unit, is unsuitable for transfer of the image information.

3. The warning device of claim 2, wherein the specifying unit specifies the communication cable by reading identification information of the communication cable or identification information that is stored in a memory of the communication cable.

4. The warning device of claim 1, further comprising a storage unit storing the history information that expresses the history of the past connected states between the connection terminal and the communication cable.

5. The warning device of claim 4, wherein the storage unit further stores history information expressing histories of past connected states between connection terminals of a plurality of radiographic devices and a plurality of communication cables, respectively.

6. The warning device of claim 1, wherein the judgment unit judges whether or not the communication cable is unsuitable for transfer of the image information by judging whether or not the history of the past connected states expressed by the history information satisfies a predetermined condition by which it is judged that the communication cable is unsuitable for transfer of the image information.

7. The warning device of claim 6, wherein the judgment unit judges that the communication cable is unsuitable for transfer of the image information in a case in which deterioration of a connected state is predicted from the history of the past connected states expressed by the history information.

8. The warning device of claim 6, wherein the judgment unit judges that the communication cable is unsuitable for transfer of the image information in a case in which a change of a connected state from the history of the past connected states expressed by the history information is greater than or equal to a predetermined amount.

9. The warning device of claim 1, wherein the history information is at least one of information that expresses a history of physically joined states between the connection terminal and the communication cable that are detected by a mechanical switch or a sensor, information that expresses a history of communication quality at times when the communication cable is connected to the connection terminal and data is transferred, and information that expresses a history of held states of the communication cable at times when the communication cable is connected to the connection terminal and is held by a holding member provided at the radiographic device.

10. The warning device of claim 1, wherein the judgment unit carries out judging at a predetermined timing of a step of preparing for capturing a radiographic image.

11. The warning device of claim 10, wherein
the radiographic device includes an electronic cassette, and
the predetermined timing includes a time when it is sensed that the electronic cassette has been taken-out from a cradle that accommodates electronic cassettes, and it is sensed that the communication cable has been taken-out from a placement stand that accommodates communication cables.

12. A computer readable medium storing a program causing a computer to execute a process for giving a warning, the process comprising:
acquiring history information expressing a history of past connected states between a communication cable and a connection terminal of a radiographic device that has a generation unit, which generates image information expressing a radiographic image expressed by irradiated radiation, and that transfers generated image information via the communication cable connected to the connection terminal;
judging, on the basis of the acquired history information, whether or not the communication cable that is connected to the connection terminal is unsuitable for transfer of the image information; and
giving a warning in a case in which it is judged that the communication cable connected to the connection terminal is unsuitable for transfer of the image information.

13. The computer readable medium of claim 12, wherein
the process further comprises specifying, among a plurality of communication cables, a communication cable that is connected to the connection terminal, and
the judging further judges whether or not the specified communication cable is unsuitable for transfer of the image information.

14. The computer readable medium of claim 13, wherein the specifying includes specifying the communication cable by reading identification information of the communication cable or identification information that is stored in a memory of the communication cable.

15. The computer readable medium of claim 12, wherein the process further comprises storing, in a storage unit, the history information that expresses the history of the past connected states between the connection terminal and the communication cable.

16. The computer readable medium of claim 12, wherein the judging further includes judging whether or not the communication cable is unsuitable for transfer of the image information by judging whether or not the history of the past connected states expressed by the history information satisfies a predetermined condition by which it is judged that the communication cable is unsuitable for transfer of the image information.

17. The computer readable medium of claim 16, wherein the judging further includes judging that the communication cable is unsuitable for transfer of the image information in a case in which deterioration of a connected state is predicted from the history of the past connected states expressed by the history information.

18. The computer readable medium of claim 16, wherein the judging further includes judging that the communication cable is unsuitable for transfer of the image information in a case in which a change of a connected state from the history of the past connected states expressed by the history information is greater than or equal to a predetermined amount.

19. The computer readable medium of claim 12, wherein the history information is at least one of information that expresses a history of physically joined states between the connection terminal and the communication cable that are detected by a mechanical switch or a sensor, information that expresses a history of communication quality at times when the communication cable is connected to the connection terminal and data is transferred, and information that expresses a history of held states of the communication cable at times when the communication cable is connected to the connection terminal and is held by a holding member provided at the radiographic device.

20. The computer readable medium of claim 12, wherein the judging further includes judging at a predetermined timing of a step of preparing for capturing a radiographic image.
